(19) United States
(12) Patent Application Publication
(10) Pub. No.: US 2017/0325434 A1
(43) Pub. Date: Nov. 16, 2017

(54) Fishing Gear

(71) Applicant: Harold Allen Walton, Taylorsville, UT (US)

(72) Inventor: Harold Allen Walton, Taylorsville, UT (US)

(21) Appl. No.: 15/592,094

(22) Filed: May 10, 2017

Related U.S. Application Data
(60) Provisional application No. 62/334,215, filed on May 10, 2016.

(51) Int. Cl. A01K 85/01; C09D 5/22; A01K 85/14; A01K 85/10; C08J 7/04; A01K 91/08; C09K 11/00; C09D 5/03

(52) U.S. Cl. CPC A01K 85/01; C09K 11/00; C09D 5/22; C09D 5/03; A01K 85/10; C08J 7/04; A01K 91/08; A01K 85/14; C08J 2369/00

(57) ABSTRACT

A pop gear or gang troll includes a wire leader and a plurality of spinner blades. The spinner blades may include a polycarbonate body or a body of some other material, a fragmented reflective material disposed on the polycarbonate body so as to reflect incident light in varying directions depending on the relative location of the incident light, and a luminescent material. The spinner blades may have a shape such as generally fish shaped, ovoid, round, or spoon shaped. A lure includes a polycarbonate body (or a body formed from some other material), a fragmented reflective material disposed on the polycarbonate body so as to reflect incident light in varying directions depending on the relative location of the incident light, a luminescent material, and a hook attached to the body. The body of the lure may have a shape designed to lure fish and/or to cause a desired motion to the lure (e.g., vibration).

### CROSS-REFERENCE TO RELATED APPLICATIONS

This application claims the benefit of U.S. Provisional Application No. 62/334,215 filed May 10, 2016.

### BACKGROUND OF THE INVENTION

### 1. Field of the Invention

The present invention relates to fishing gear, and more particularly to fishing gear for use with trolling and other movement-based fishing techniques, such as gang trolls, pop gear, and lures.

### 2. Background and Related Art

Trolling is a method of fishing where one or more fishing lines, baited with lures or bait fish, are drawn through the water. Trolling may occur behind a moving boat, by slowly winding in the line, or by sweeping the line from side to side. At times, gang trolls, otherwise known as pop gear, can be used with trolling, and are designed to attract the attention of fish through vibration, color, and/or flashing reflected light. The gang troll or pop gear typically consists of a wire leader with a number of spinner blades that can vary in shape and size depending on the intended use. Additionally, specially designed lures may be used that are also designed to attract fish using vibration, color, and/or flashing reflected light. While varieties of such fishing gear have been long in use, there is room for new and improved versions of such fishing gear.

### BRIEF SUMMARY OF THE INVENTION

According to certain implementations of the invention, a pop gear or gang troll includes a wire leader and a plurality of spinner blades. The spinner blades may include a polycarbonate body or a body of some other material, a fragmented reflective material disposed on the polycarbonate body so as to reflect incident light in varying directions depending on the relative location of the incident light, and a luminescent material. The spinner blades may have a shape such as generally fish shaped, ovoid, round, or spoon shaped.

The spinner blades may include a first layer applied to the polycarbonate body that includes the luminescent material, a solvent adhesive, and glitter. Alternately, the first layer may be formed of multiple individual layers. The spinner blades may include a second layer applied to the first layer, the second layer including a solvent cement and additional glitter. Alternatively, the second layer may be formed of multiple individual layers. In some implementations, the spinner blades include a first layer (or layers) applied to the polycarbonate body including the luminescent material, a solvent adhesive, glitter, and paint. In such implementations, the spinner blades may include a second layer (or layers) applied to the first layer, the second layer comprising a solvent cement and additional glitter.

The luminescent material of the spinner blade may be a phosphorescent powder. The polycarbonate body may be formed from a sheet of polycarbonate material having a thickness of approximately 1/64 inch to 3/64 inch.

According to certain additional implementations of the invention, a lure includes a polycarbonate body (or a body formed from some other material), a fragmented reflective material disposed on the polycarbonate body so as to reflect incident light in varying directions depending on the relative location of the incident light, a luminescent material, and a hook attached to the body. The body of the lure may have a shape designed to lure fish and/or to cause a desired motion to the lure (e.g., vibration).

The lure may include a first layer applied to the polycarbonate body that includes the luminescent material, a solvent adhesive, and glitter. Alternatively, the first layer may be formed of multiple individual layers. The lure may include a second layer applied to the first layer, the second layer including a solvent cement and additional glitter. Alternatively, the second layer may be formed of multiple individual layers. In some implementations, the lure includes a first layer (or layers) applied to the polycarbonate body that includes the luminescent material, a solvent adhesive, glitter, and paint. In such implementations, the lure may include a second layer (or layers) applied to the first layer, the second layer including a solvent cement and additional glitter.

The luminescent material of the lure may be a phosphorescent powder. The polycarbonate body is formed from a sheet of polycarbonate material having a thickness of between 3/32 inch and 3/16 inch

According to certain other implementations of the invention, a method for manufacturing pop gear spinners and fishing lures includes steps of cutting a piece of polycarbonate material approximating a desired shape of a pop gear spinner or fishing lure from a sheet of polycarbonate material, heating and shaping the piece of polycarbonate material into a desired final shape, applying a solution comprising a solvent cement, a luminescent material, and a fragmented reflective material to the piece of polycarbonate material, and applying a solution comprising a solvent cement and a fragmented reflective material to the piece of polycarbonate material.

The luminescent material used in the method may be a phosphorescent powder. The sheet of polycarbonate material used in the method may have a thickness of between 1/64 inch and 3/16 inch. The method may further include a step of applying paint to the piece of polycarbonate material. The method may also further include cleaning the piece of polycarbonate material before applying the solution comprising a solvent cement, a luminescent material, and a fragmented reflective material, such as with a chemical cleaner.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIGS. 1-4 show representative gang trolls or pop gear;

FIG. 5 shows the representative gang trolls or pop gear of FIGS. 1-4 in a darkened environment;

FIGS. 5-8 show representative lures; and

FIGS. 9-10 show the representative lures of FIGS. 5-8 in a darkened environment.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

According to certain embodiments of the invention, a pop gear or gang troll includes a wire leader and a plurality of spinner blades. The spinner blades may include a polycarbonate body or a body of some other material, a fragmented reflective material disposed on the polycarbonate body so as to reflect incident light in varying directions depending on the relative location of the incident light, and a luminescent material. The spinner blades may have a shape such as generally fish shaped, ovoid, round, or spoon shaped.

The spinner blades may include a first layer applied to the polycarbonate body that includes the luminescent material, a solvent adhesive, and glitter. Alternately, the first layer may be formed of multiple individual layers. The spinner blades may include a second layer applied to the first layer, the second layer including a solvent cement and additional glitter. Alternatively, the second layer may be formed of multiple individual layers. In some embodiments, the spinner blades include a first layer (or layers) applied to the polycarbonate body including the luminescent material, a solvent adhesive, glitter, and paint. In such embodiments, the spinner blades may include a second layer (or layers) applied to the first layer, the second layer comprising a solvent cement and additional glitter.

The luminescent material of the spinner blade may be a phosphorescent powder. The polycarbonate body may be formed from a sheet of polycarbonate material having a thickness of approximately 1/64 inch to 3/64 inch.

According to certain additional embodiments of the invention, a lure includes a polycarbonate body (or a body formed from some other material), a fragmented reflective material disposed on the polycarbonate body so as to reflect incident light in varying directions depending on the relative location of the incident light, a luminescent material, and a hook attached to the body. The body of the lure may have a shape designed to lure fish and/or to cause a desired motion to the lure (e.g., vibration).

The lure may include a first layer applied to the polycarbonate body that includes the luminescent material, a solvent adhesive, and glitter. Alternatively, the first layer may be formed of multiple individual layers. The lure may include a second layer applied to the first layer, the second layer including a solvent cement and additional glitter. Alternatively, the second layer may be formed of multiple individual layers. In some embodiments, the lure includes a first layer (or layers) applied to the polycarbonate body that includes the luminescent material, a solvent adhesive, glitter, and paint. In such embodiments, the lure may include a second layer (or layers) applied to the first layer, the second layer including a solvent cement and additional glitter.

The luminescent material of the lure may be a phosphorescent powder. The polycarbonate body is formed from a sheet of polycarbonate material having a thickness of between 3/32 inch and 3/16 inch

According to certain other embodiments of the invention, a method for manufacturing pop gear spinners and fishing lures includes steps of cutting a piece of polycarbonate material approximating a desired shape of a pop gear spinner or fishing lure from a sheet of polycarbonate material, heating and shaping the piece of polycarbonate material into a desired final shape, applying a solution comprising a solvent cement, a luminescent material, and a fragmented reflective material to the piece of polycarbonate material, and applying a solution comprising a solvent cement and a fragmented reflective material to the piece of polycarbonate material.

The luminescent material used in the method may be a phosphorescent powder. The sheet of polycarbonate material used in the method may have a thickness of between 1/64 inch and 3/16 inch. The method may further include a step of applying paint to the piece of polycarbonate material. The method may also further include cleaning the piece of polycarbonate material before applying the solution comprising a solvent cement, a luminescent material, and a fragmented reflective material, such as with a chemical cleaner.

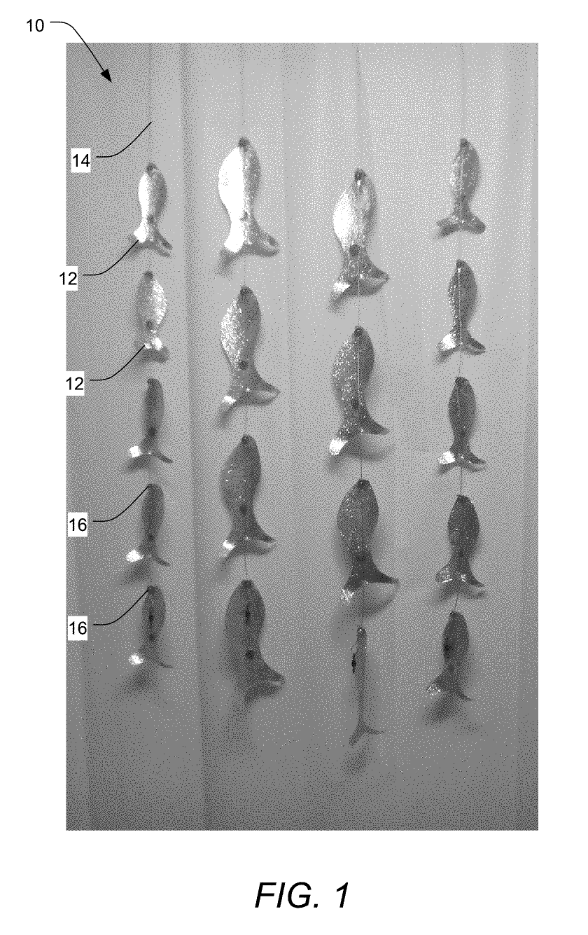

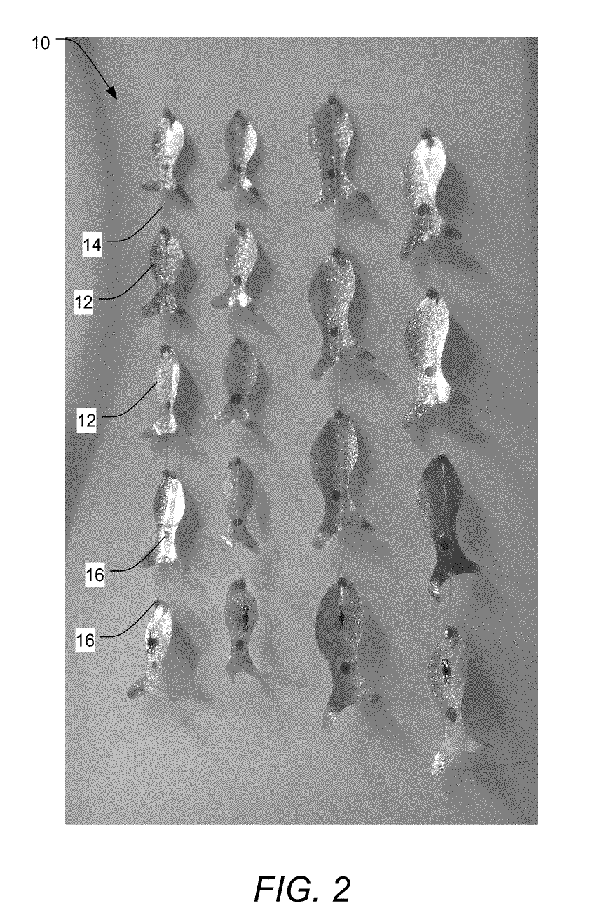

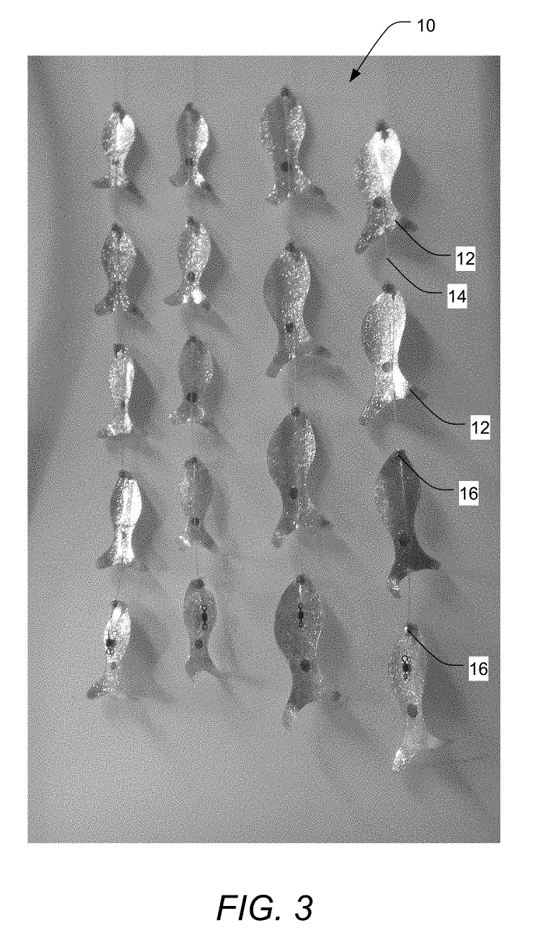

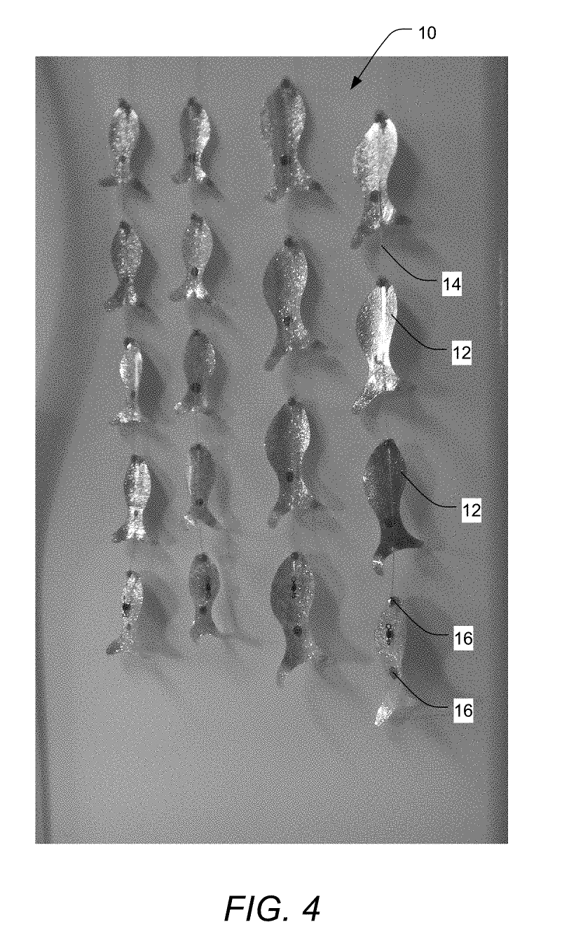

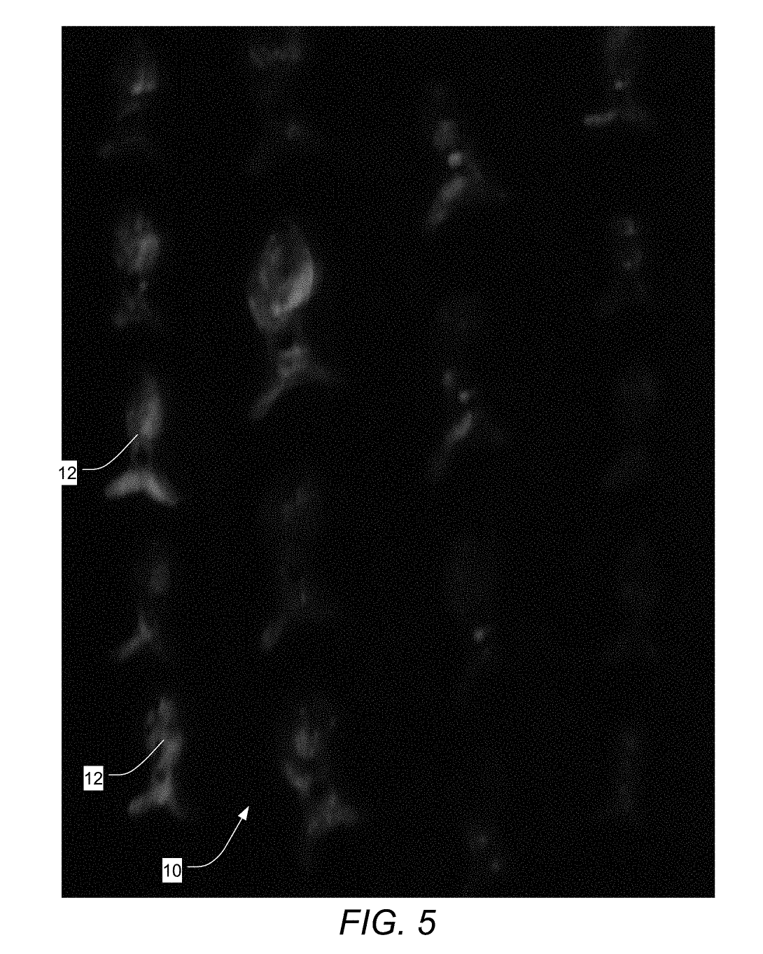

FIGS. 1-5 illustrate representative gang trolls or pop gear (“pop gear 10”) in accordance with embodiments of the invention. FIGS. 1-4 illustrate the pop gear 10 in a well-lighted environment, while FIG. 5 illustrates the pop gear 10 in a darkened environment. Each pop gear 10 includes a number of spinner blades 12 attached to a wire leader 14. Optionally, the pop gear 10 may include small spheres or beads 16 spaced along the leader 14, which beads 16 may be red in color.

As may be seen in the Figures, the size of each spinner blade 12 may vary from pop gear 10 to pop gear 10 as well as within a single pop gear 10. Additionally, the spinner blades 12 may be formed in a variety of shapes. For example, as illustrated in FIGS. 1-5, the spinner blades 12 may be formed in a general or stylized shape of a fish. The spinner blades 12 may be formed in other shapes such as generally oblong shapes, oval shapes, circular shapes, diamond shapes, and any of a variety of other regular and irregular shapes.

Regardless of the shape chosen for the spinner blades 12, the spinner blades 12 may incorporate a reflective material, and may be formed in a variety of colors, such as silver or gold. As may be seen in FIG. 5, the spinner blades 12 may incorporate a material that is photoluminescent (e.g., phosphorescent) or that glows in the dark after exposure to light. The photoluminescence of the spinner blades 12 may allow the pop gear 10 to be attractive to fish in the absence of external light sources, such as at depths where sunlight cannot reach or during nighttime hours.

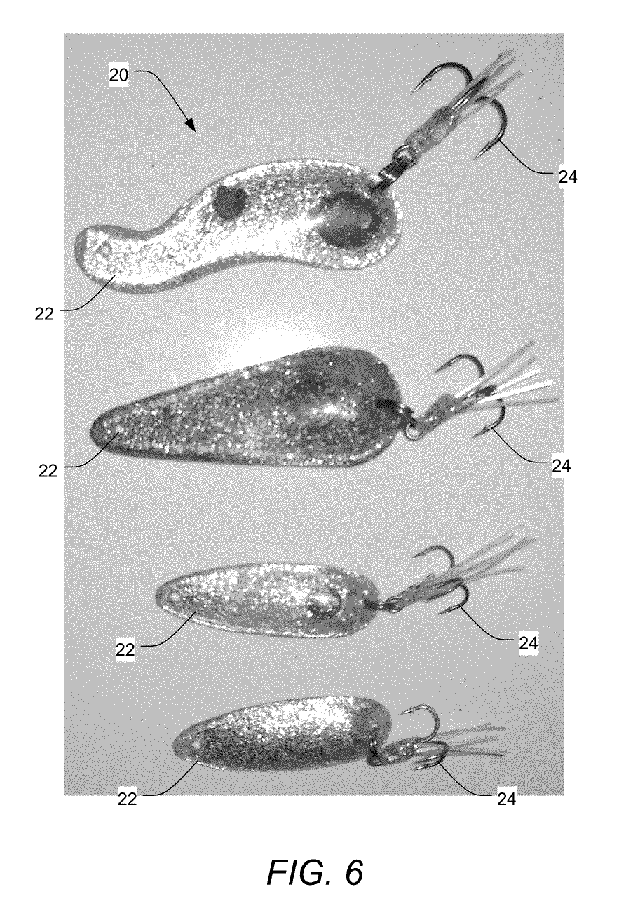

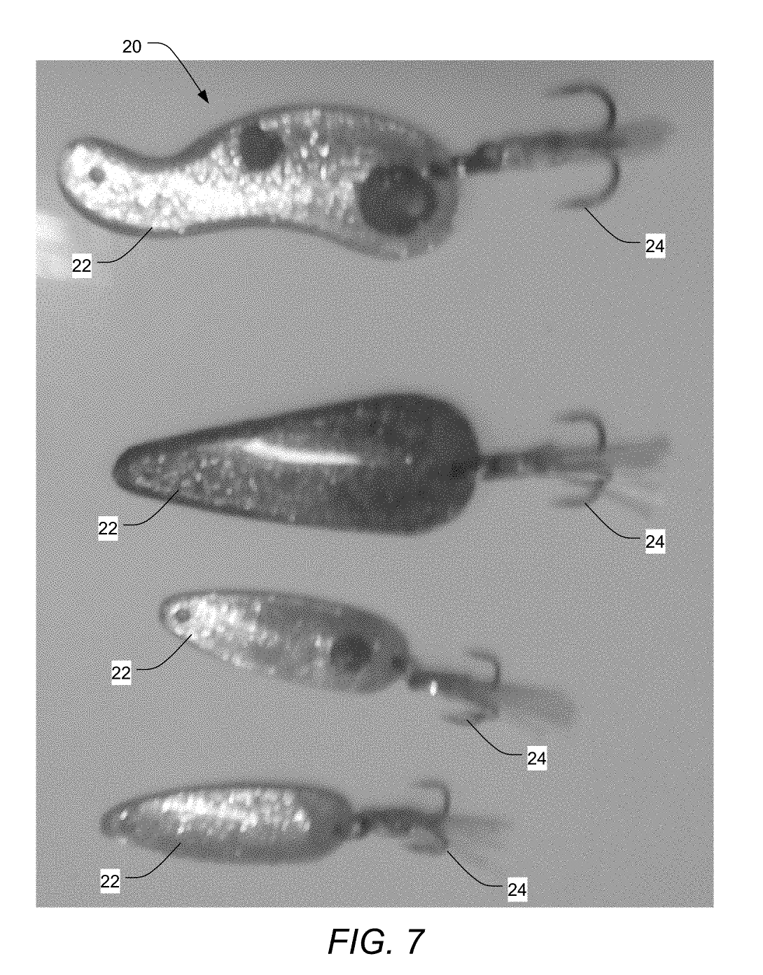

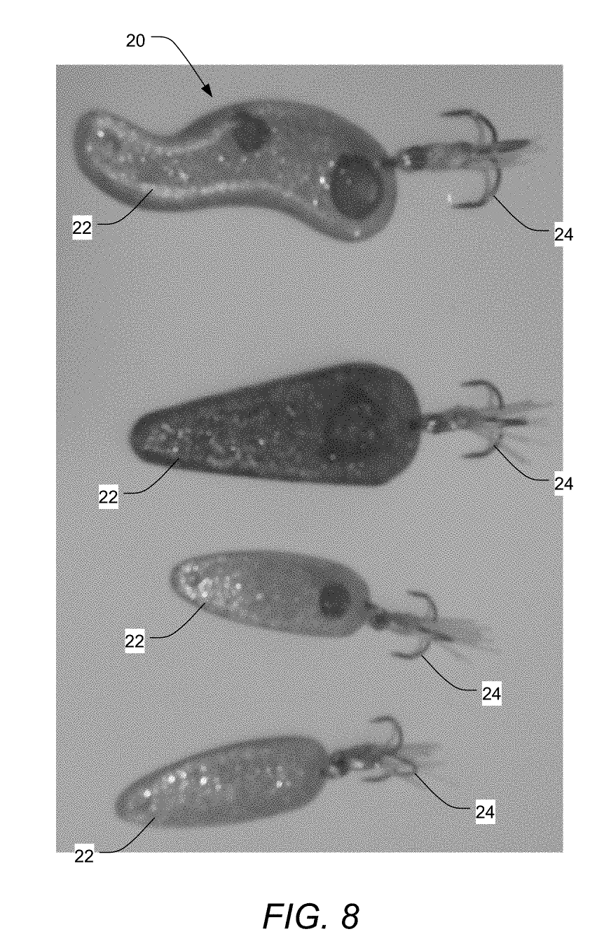

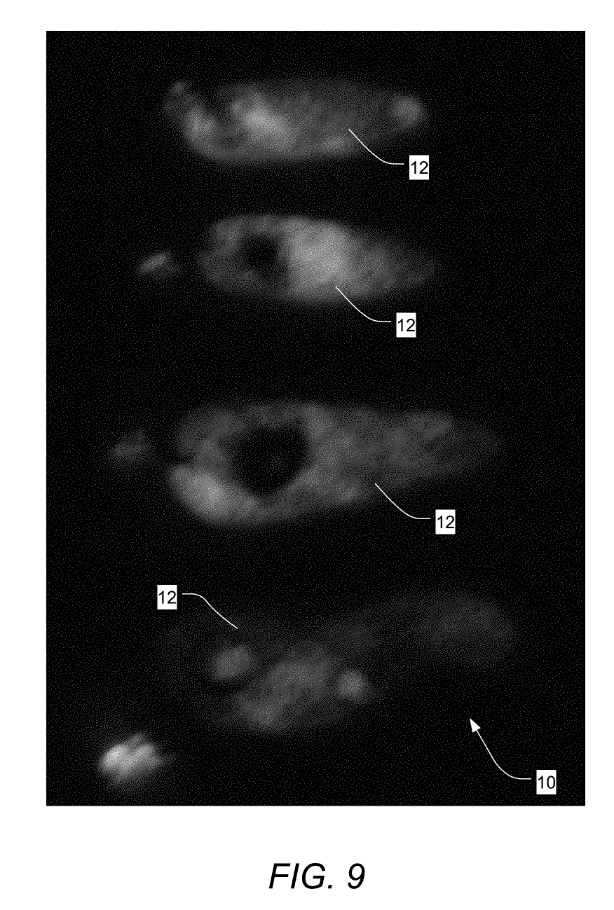

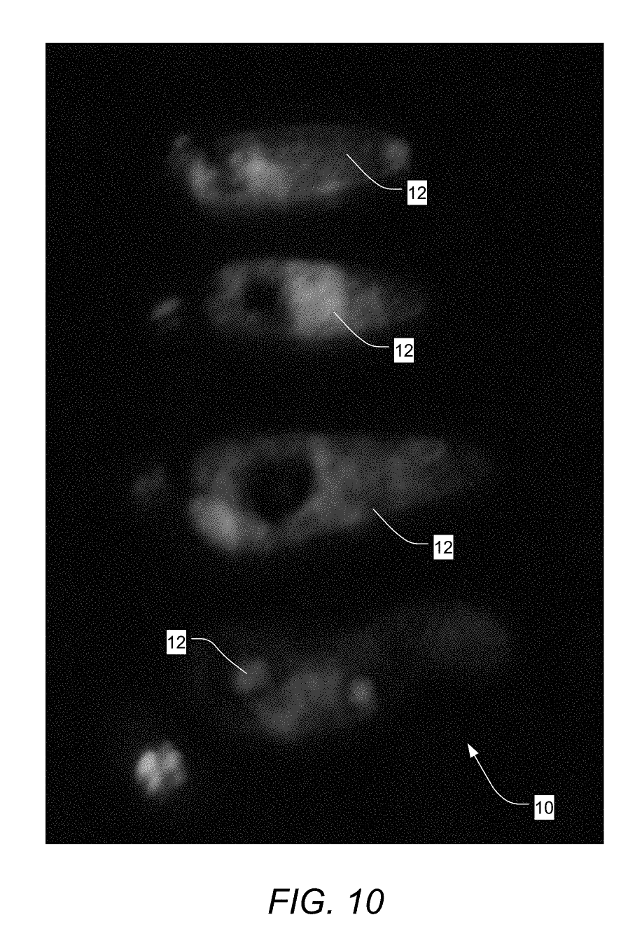

FIGS. 6-10 illustrate representative lures 20 in accordance with embodiments of the invention. FIGS. 6-8 illustrate the lures 20 in a well-lighted environment, while FIGS. 9-10 illustrate the lures in a darkened environment, illustrating the similar photoluminescence of the embodiments of the lures 20. While the illustrative pop gear 10 and lures 20 utilize photoluminescence to provide fish-attracting light, other forms of luminescence may be utilized with certain embodiments of the invention, including chemiluminescence, electroluminescence, or any other applicable method of providing luminescence to the pop gear 10 and/or lures 20.

The lures 20 may each include a body 22 which may take a variety of sizes and shapes designed to mimic a bait fish or attract the target fish, or to cause a desired vibrational motion, as may be seen by the variety of sizes and shapes shown in FIG. 6. As with the pop gear 10, the lures 20 may incorporate a reflective material and may be formed in a variety of colors, such as silver, gold, green, red, etc. Additionally, the lures 20 (and the pop gear 10) may incorporate spots or other patterns of differing colors. The lures 20 also include one or more hooks 24 serving to hook and secure fish that attempt to eat or bite the lures 20, as is known in the fishing art.

While the spinner blades 12 of the pop gear 10 and the bodies 22 of the lures 20 may be made using a variety of materials and via a variety of methods, one exemplary method of construction is described herein. According to this exemplary method, polycarbonate plastic sheets are used as a base material for the spinner blades 12 and the bodies 22. The thickness of the polycarbonate plastic sheets for each spinner blade 12 or body 22 used may vary depending on the specific size and/or desired functional characteristic of the specific blade 12 or body 22. By way of example, where smaller and/or thinner spinner blades 12 or body 22 are desired, a thinner sheet of polycarbonate may be used, such as a 1/32 inch sheet of polycarbonate. Where larger or thicker spinner blades 12 or body 22 are desired, a thicker sheet of polycarbonate may be used, such as a 1/16 inch or ⅛ inch sheet of polycarbonate. It may be appreciated that any other dimension of polycarbonate sheet material may be used even though not specifically listed herein. Spinner blades 12 will not typically have large loads placed upon them, and may generally be formed using a thinner material, while bodies 22 will have the load of a caught fish placed upon them and may generally be formed using a thicker material for additional strength.

The individual spinner blades 12 and bodies 22 may be cut in their appropriate shape from the sheet material, or in a shape near the final intended shape, using any applicable method, such as by stamping, CNC routing, laser cutting, and the like. Once the individual spinner blades 12 and bodies 22 are cut from the sheet material, they may be heated (e.g., using a heat gun) and molded (e.g. using a mold) to assume a more-complex and final shape, including shapes with various curvatures whereby the spinner blades 12 and/or bodies 22 may have appropriate functional characteristics (e.g., a desired vibrational, spinning, or dragging performance). The spinner blades 12 and/or bodies 22 may also have any necessary holes formed so as to permit attachment to the wire leader 14 or any device used to attach the spinner blades 12 and/or bodies 22 to the fishing line.

After the spinner blades 12 and/or bodies 22 are shaped and molded to the desired finished shape, the polycarbonate may be cleaned with a chemical cleaner, and a phosphorescent powder, weld-on solvent, paint, and glitter may be applied to the shaped and cleaned spinner blades 12 and/or bodies 22. Then, a weld-on bond, a filler bond, and glitter may be mixed and applied as a top coat to the spinner blades 12 and/or bodies 22.

By way of example, the phosphorescent powder used may be Glow Worm green phosphorescent powder from Reynolds Advanced Materials, a division of Smooth-On, Inc.

Additionally, by way of example, the solvent used may be SCIGRIP 3 solvent cement by SCIGRIP Adhesives Ltd. (which comprises, according to the manufacturer, 75-90% methylene chloride by weight, 5-15% trichloroethylene by weight, and 1-2% methyl methacrylate monomer by weight. The filler used, by way of example, may be SCIGRIP 16 solvent cement by SCIGRIP Smarter Adhesive Solutions (which comprises, according to the manufacturer, 30-60% by weight methylene chloride, 10-15% by weight methyl acetate, 10-30% by weight methyl ethyl ketone, and 0-2% by weight methyl methacrylate monomer). By way of example, the glitter used may be any of those provided by Roth Metal Flake of Fremont, Calif.

While examples have been discussed herein with respect to the use of polycarbonate for the base material of the spinner blades 12 and/or bodies 22, the use of additional or alternate materials is embraced. Such additional materials may include other plastics, resins, metals, or any other material capable of serving the purposes discussed herein. While polycarbonate and similar plastics are inexpensive and easy to form as discussed herein, the use of other materials, including dissimilar materials, is embraced.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A pop gear or gang troll comprising:
a wire leader; and
a plurality of spinner blades comprising:
a polycarbonate body;
a fragmented reflective material disposed on the polycarbonate body so as to reflect incident light in varying directions depending on the relative location of the incident light; and
a luminescent material.

2. The pop gear or gang troll as recited in claim 1, wherein the spinner blades comprise a shape selected from the group consisting of:
generally fish shaped;
ovoid;
round; and
spoon shaped.

3. The pop gear or gang troll as recited in claim 1, wherein the spinner blades comprise a first layer applied to the polycarbonate body comprising the luminescent material, a solvent adhesive, and glitter.

4. The pop gear or gang troll as recited in claim 3, wherein the spinner blades comprise a second layer applied to the first layer, the second layer comprising a solvent cement and additional glitter.

5. The pop gear or gang troll as recited in claim 1, wherein the spinner blades comprise a first layer applied to the polycarbonate body comprising the luminescent material, a solvent adhesive, glitter, and paint.

6. The pop gear or gang troll as recited in claim 3, wherein the spinner blades comprise a second layer applied to the first layer, the second layer comprising a solvent cement and additional glitter.

7. The pop gear or gang troll as recited in claim 1, wherein the luminescent material comprises a phosphorescent powder.

8. The pop gear or gang troll as recited in claim 1, wherein the polycarbonate body is formed from a sheet of polycarbonate material having a thickness of approximately 1/64 inch to 3/64 inch.

9. A lure comprising:
a polycarbonate body;
a fragmented reflective material disposed on the polycarbonate body so as to reflect incident light in varying directions depending on the relative location of the incident light;
a luminescent material; and
a hook attached to the body.

10. The lure as recited in claim 9, wherein the lure comprises a first layer applied to the polycarbonate body comprising the luminescent material, a solvent adhesive, and glitter.

11. The lure as recited in claim 10, wherein the lure comprises a second layer applied to the first layer, the second layer comprising a solvent cement and additional glitter.

12. The pop gear or gang troll as recited in claim 9, wherein the lure comprises a first layer applied to the polycarbonate body comprising the luminescent material, a solvent adhesive, glitter, and paint.

13. The pop gear or gang troll as recited in claim 12, wherein the lure comprises a second layer applied to the first layer, the second layer comprising a solvent cement and additional glitter.

14. The lure as recited in claim 9, wherein the luminescent material comprises a phosphorescent powder.

15. The lure as recited in claim 9, wherein the polycarbonate body is formed from a sheet of polycarbonate material having a thickness of between 3/32 inch and 3/16 inch

16. A method for manufacturing pop gear spinners and fishing lures comprising:
cutting a piece of polycarbonate material approximating a desired shape of a pop gear spinner or fishing lure from a sheet of polycarbonate material;
heating and shaping the piece of polycarbonate material into a desired final shape;
applying a solution comprising a solvent cement, a luminescent material, and a fragmented reflective material to the piece of polycarbonate material; and
applying a solution comprising a solvent cement and a fragmented reflective material to the piece of polycarbonate material.

17. The method for manufacturing pop gear spinners and fishing lures as recited in claim 16, wherein the luminescent material comprises a phosphorescent powder.

18. The method for manufacturing pop gear spinners and fishing lures as recited in claim 16, wherein the sheet of polycarbonate material comprises a thickness of between 1/64 inch and 3/16 inch.

19. The method for manufacturing pop gear spinners and fishing lures as recited in claim 16, further comprising applying paint to the piece of polycarbonate material.

20. The method for manufacturing pop gear spinners and fishing lures as recited in claim 16, further comprising cleaning the piece of polycarbonate material before applying the solution comprising a solvent cement, a luminescent material, and a fragmented reflective material.
